(19) United States
(12) Patent Application Publication
(10) Pub. No.: US 2010/0111180 A1
(43) Pub. Date: May 6, 2010

(54) Scene change detection

(76) Inventors: John Gao, Coventry (GB); Peter Leaback, London (GB); Mingyou Hu, Cambridge (GB)

Correspondence Address: FLYNN THIEL BOUTELL & TANIS, P.C., 2026 RAMBLING ROAD, KALAMAZOO, MI, 49008-1631, US

(21) Appl. No.: 12/387,154

(22) Filed: Apr. 28, 2009

(30) Foreign Application Priority Data
Apr. 29, 2008 (GB) 0807790.1

(51) Int. Cl. H04N 7/32

(52) U.S. Cl. 375/240.13; 375/240.12; 375/E07.243

(57) ABSTRACT

There is provided a method and apparatus for scene change detection for use with bit-rate control of a video compression system. The method and apparatus may be used for scene change detection in intra-coded and/or inter-coded pictures. The method comprises the steps of: compressing each picture in a video signal in turn; determining complexity data from the compressed signal for each picture after partial compression of the picture; determining from the complexity data whether a scene change may have taken place; and adjusting the compression step and allocated compressed bit number for pictures after a scene change detection in dependence on the result of the determination. For an intra-coded picture, the complexity data is a monotonically increasing function of a quantisation parameter and a compressed bit number used in the compression step for the partial compression from which the complexity data is determined. For an inter-coded picture, the complexity data is determined from a combination of a) the change of temporal prediction difference in relation to the average prediction difference of previous inter-coded pictures, b) the intra-coded macroblock number in the current inter-coded picture in relation to the average intra-coded macroblock number in previous inter-coded pictures, and c) the intra-coded macroblock number in the current inter-coded picture in relation to the total encoded macroblock number in the current inter-coded picture.

This invention relates to a method and apparatus for scene change detection in bit-rate control of video compression systems.

### BACKGROUND OF THE INVENTION

Within the past decade, much improvement on network bandwidth has been achieved in order to build real-time video and audio systems and provide service such as video-on-demand and videoconferencing to users over telecoms networks, for example. However, network bandwidth is still the main inhibitor to the effectiveness of such systems. In order to overcome the constraints imposed by networks, different video compression systems have been employed. These compression systems can reduce the amount of video data by removing the redundancy from the video frame and from the video sequence. At the receiving end, the picture sequence is decompressed and is displayed in real-time.

One example of video compression standard is the H.264. In this standard, video compression is achieved through compression within a picture and compression between pictures.

Video compression within a picture is accomplished by intra-picture prediction. This comprises predicting one part of the current video picture from other parts of it, e.g. by intra interpolation. A prediction error is then determined from a comparison of predicted pixel values with actual pixel values. The prediction errors can then be transformed into the frequency domain by using a fast integer transform. This frequency domain representation is then quantised by dividing it by a predetermined number and finally coded using variable length coding (VLC).

Video compression between pictures again uses an estimation or prediction to predict the pixels in current picture from the pixels in previously coded pictures. This is what is known as motion estimation or inter picture predication. Again, the prediction error is derived and is transformed to the frequency domain. From the frequency domain, the prediction error is quantised and encoded using variable length coding.

When compressing a picture, it is split to many non-overlapping 16×16 macroblocks. The encoder compresses a picture by processing each of its macroblocks in raster order. A high level of compression system architecture suitable for performing this type of coding is shown in FIG. 1. An input video signal, provided to a multi-frame buffer 2, is sent to a Motion Estimation unit 4 to find the best motion vectors from previous encoded pictures, for each of the macroblocks in the current picture. The Motion Compensation unit 6 calculates the inter picture prediction of a current picture based on the motion vectors. Also, an Intra Picture Prediction unit 8 determines the best intra prediction for a current macroblock. Then the best intra or inter picture prediction with lower coding cost is selected and corresponding pixel residuals derived in a subtractor 10 are sent to a pixel encoding unit 12 to form a final bit stream. The pixel encoder unit includes Transform 14, Quantization 16 and VLC 17.

In addition, to obtain a reference picture for the picture compression, there is a local decoder loop that consists of Inverse Quantization 20, Inverse Transform 21, Pixel Reconstruction 23 and De-blocker 25. After Inverse Quantization and Inverse Transform, the decoded pixel residuals are calculated and then they are added to the corresponding intra/inter predictors to get decoded pixels. Finally the De-blocker is used to smooth the edge effect before the decoded pixels are sent to the multi-frame buffer as a reference picture for a future picture.

Detailed video compression system architecture of H.264/MPEG-4 AVC was described in Thomas Wiegand, Gary J. Sullivan, etc., “Overview of the H.264/AVC Video Coding Standard”, IEEE Trans. on CSVT, Vol. 13, No. 7, pp. 560-576, July 2003.

In order to achieve effective transmission bandwidth, the compression system is sometimes required to generate a substantially constant bit rate. However, the number of bits needed to represent any picture is directly related to the complexity of the picture content. Thus, each picture may have a different number of bits.

The rate control block in a video compression system is used to regulate the bit number amount of compressed video pictures and to maintain an approximately constant bit rate to the decoder, while keeping a substantially uniform picture quality.

The requirement to produce substantial quality uniformity within a picture and between pictures means that the quantisation parameter (QP) has to vary smoothly from macroblock to macroblock and from frame to frame. The Quantisation Parameter (QP) determines the step size of quantization for associating the transformed coefficients in the frequency domain with a finite set of steps, as described by Khalid Sayood in “Introduction to Data Compression (3^{rd} Edition)”, Morgan Kaufmann Publications, 2005. Large values of QP represent bit steps that crudely approximate the spatial transform, so that most of the signal can be captured by only a few coefficients. Small values of QP more accurately approximate the block's spatial frequency spectrum, but at the cost of more bits.

When there is a big change in picture content or the scenes between two frames, the compressed bit number of a new frame would have a big difference from an estimated bit number based on previous encoded frames. So the quantisation parameter has to change abruptly in order to generate a constant bit rate. Thus, scene change detection is needed to determine if two adjacent pictures are similar or very different.

Many scene change detection methods have been used in the past. Most of them are proposed for video editing and retrieval. Some scene-adaptive rate control algorithms have also been developed and most of them are achieved through pre-analysis or multi-pass processing before compression starts. The most common characteristics used for scene change detection are:
1. brightness/colour signal histograms,
2. variation degree of edge information,
3. histogram differences and difference of the DC images of pixels,
4. motion characteristics, motion vector difference, motion vector smoothness,
5. temporal prediction difference,
6. large changes in compressed data size.

For example, to reduce the impact of scene changes, a rate control scheme for MPEG-2 using scene change detection is proposed by Sanggyu Park, etc., “A new MPEG-2 rate control scheme using scene change detection”, ETRI Journal, Vol. 18, No. 2, July 1996. Through looking ahead and pre-analysis, a new scene is detected by using the signed difference of temporal prediction mean absolute difference (MAD). The disadvantage of this method is that its detection performance is limited by the selection of a threshold which seriously depends on the variance of texture.

The method in M. Lee, etc., “A Scene Adaptive Bitrate Control Method in MPEG Video Coding”, in Proc. SPIE, Vol. 3024, p. 1406-1416, 1997, predicts the coding complexity of a picture using the spatial variance before DCT and spectral flatness measure. It is too complex to be implemented in a real-time compression system. Furthermore, it requires a pre-analysis process of next frame before scene change detection.

The method in Danilo Pau, etc., “Detection of a Change of Scene in a Motion Estimator of a Video Encoder”, U.S. Pat. No. 6,480,543B1, Nov. 12, 2002, detects a new scene by checking two indexes: the average number of a texture smoothness index and the smoothness index of a motion field of each picture. Normally, the estimated motion field is inaccurate for the first frame of a new scene.

In Jong, etc., “Scene Change Detection Apparatus”, U.S. Pat. No. 7,158,674B2, Jan. 2, 2007, an apparatus for detecting a scene change is disclosed, which is used for video indexing and key frame generation in a personal video recorder. In this apparatus, the accumulated histograms are extracted from two frames and then a pixel value corresponding to a specific accumulated distribution of respective accumulated histograms. Accurate scene change can be detected by comparing the difference of pixel value lists. This method can hardly be used in real-time video compression systems due to its computational complexity.

In the method of Michael A. Kutner, “One-pass Adaptive Bit Rate Control”, U.S. Pat. No. 5,489,943, Feb. 6, 1996, scene changes are easily detected if large changes in compressed data size are generated.

Some methods use the above characteristics in combination to improve the robustness of detection. For example, a one-pass VBR MPEG encoder is proposed in Akio Yoneyama, etc., “One-pass VBR MPEG Encoder using Scene Adaptive Dynamic GOP Structure”, International Conference on Consumer Electronics, 2001, Page(s):174-175, which pre-analyses the texture and motion characteristics of preloaded pictures during scene change detection. The computational complexity is too high to achieve real-time video compression.

It will be appreciated that the scene change detection methods described above have disadvantages.

First, some of above schemes, such as those based on histogram and edge information, are too complex to be implemented by a real-time hardware video compression system. These methods are mainly used in video indexing and retrieving.

Second, some of the schemes, which are based on motion characteristics such as motion vector smoothness and motion vector difference, cannot achieve real-time performance, as pre-analysis or two-pass analysis is needed to obtain the corresponding information.

Third, for rate control applications, scene change should be detected as early as possible so that the bit number used to compress the first frame of a scene change is not too high and the compression performance of subsequent frames does not drop much. The above discussed methods cannot achieve this, as they will use the information from the whole frame.

### SUMMARY OF THE INVENTION

According to the invention, there is provided a method for scene change detection in intra-coded pictures for use with bit-rate control of a video compression system, the method comprising the steps of: compressing each intra-coded picture in a video signal in turn; determining complexity data from the compressed signal for each intra-coded picture after partial compression of the picture; determining from the complexity data whether a scene change may have taken place; and adjusting the compression step and allocated compressed bit number for intra-coded pictures after a scene change detection in dependence on the result of the determination, wherein, for an intra-coded picture, the complexity data is a monotonically increasing function of a quantisation parameter and a compressed bit number used in the compression step for the partial compression from which the complexity data is determined.

According to the invention, there is also provided a method for scene change detection in inter-coded pictures for use with bit-rate control of a video compression system, the method comprising the steps of: compressing each inter-coded picture in a video signal in turn; determining complexity data from the compressed signal for each inter-coded picture after partial compression of the picture; determining from the complexity data whether a scene change may have taken place; and adjusting the compression step and allocated compressed bit number for inter-coded pictures after a scene change detection in dependence on the result of the determination, wherein, for an inter-coded picture, the complexity data is determined from a combination of a) the change of temporal prediction difference in relation to the average prediction difference of previous inter-coded pictures, b) the intra-coded macroblock number in the current inter-coded picture in relation to the average intra-coded macroblock number in previous inter-coded pictures, and c) the intra-coded macroblock number in the current inter-coded picture in relation to the total encoded macroblock number in the current inter-coded picture.

According to the invention, there is also provided an apparatus for scene change detection in intra-coded pictures with bit-rate control of a video compression system, the apparatus comprising: means for compressing each intra-coded picture in a video signal in turn; means for determining complexity data from the compressed signal for each intra-coded picture after partial compression of the picture; means for determining from the complexity data whether a scene change may have taken place; and means for adjusting the compression step and allocated compressed bit-number for intra-coded pictures after scene change detection in dependence on the result of the determination, wherein, for an intra-coded picture, the complexity data is a monotonically increasing function of a quantisation parameter and a compressed bit number used in the compression step for the partial compression from which the complexity data is determined.

According to the invention, there is also provided an apparatus for scene change detection in inter-coded pictures for use with bit-rate control of a video compression system, the apparatus comprising: means for compressing each inter-coded picture in a video signal in turn; means for determining complexity data from the compressed signal for each inter-coded picture after partial compression of the picture; means for determining from the complexity data whether a scene change may have taken place; and means for adjusting the compression step and allocated compressed bit-number for inter-coded pictures after scene change detection in dependence on the result of the determination, wherein, for an inter-coded picture, the complexity data is determined from a combination of a) the change of temporal prediction difference in relation to the average prediction difference of previous inter-coded pictures, b) the intra-coded macroblock number in the current inter-coded picture in relation to the average intra-coded macroblock number in previous inter-coded pictures, and c) the intra-coded macroblock number in the current inter-coded picture in relation to the total encoded macroblock number in the current inter-coded picture.

An intra-coded frame is a frame in which all of its pixels are predicted only from pixels of itself during video compression, whilst an inter-coded frame is a frame that has some or all of its pixels predicted from pixels of previous and/or following frames. A sudden scene change will normally cause a much bigger number of macroblocks to be intra-coded in an inter-coded picture as the inter prediction from a previous picture would not be good after a scene change

The method and apparatus of the invention are advantageous since all the characteristics can be obtained during a real-time video compression process without pre-analysis and/or two-pass analysis required. In addition, the complexity data for both inter-coded and inter-coded pictures is dependent on two parameters, which results in more accurate and improved performance scene change detection. One embodiment of the present invention provides a complexity definition for an intra-coded frame: It is more robust and accurate to characterise when detecting a scene change in intra-coded frames than the use of the generated bit numbers which can be problematic when there is a large change.

Preferred features of the invention are set out in the dependent claims.

### BRIEF DESCRIPTION OF THE DRAWINGS

FIG. 1 is a block diagram of a high level compression system of the type to which the present invention may be applied.

FIG. 2 is a block diagram of a compression system with scene adaptive rate control embodying the invention; and

FIG. 3 is a flow chart showing how the scene detection in scene adaptive control of FIG. 2 is performed.

### DETAILED DESCRIPTION OF A PREFERRED EMBODIMENT

As already mentioned, an intra-coded frame is a frame in which all of its pixels are predicted only from pixels of itself during video compression, whilst an inter-coded frame is a frame that has some or all of its pixels predicted from pixels of previous and/or following frames. A sudden scene change will normally cause a much bigger number of macroblocks to be intra-coded in an inter-coded picture as the inter prediction from a previous picture would not be good after a scene change.

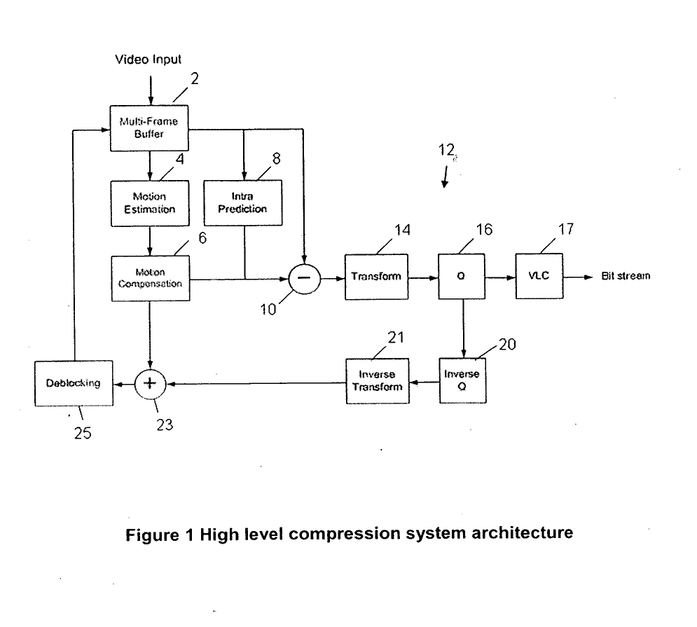

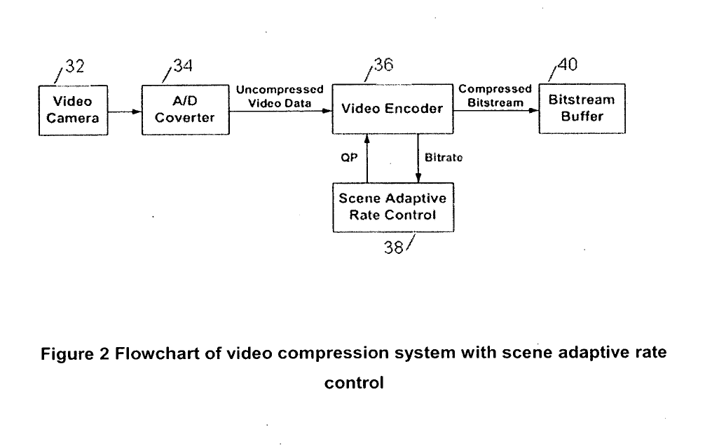

FIG. 2 shows a block diagram of a video compression system embodying the invention. A video camera 32 to provides a video signal to an analogue to digital converter 34. This provides uncompressed digital video data picture by picture to an encoder 36. This encoder is able to compress pictures of the uncompressed video source into a bit stream in a manner as described with reference to FIG. 1 by using quantisation parameters provided by a scene adaptive rate control unit 38. The output of the encoder 36 is a compressed bit stream which can be stored, broadcast, or otherwise used. In this example, it is shown going to a storage device 40 (bit stream buffer).

In order to achieve a predetermined bit rate, the scene adaptive rate control unit 38 is adapted to dynamically adjust quantisation parameters (QP) provided to the encoder 36. This dynamic adjustment is performed in response to an input bit rate and a predetermined output bit rate as well as an estimate of the picture complexity. It also allocates a budget or predetermined number of bits to each group of pictures in the scene, or to individual pictures and/or sub pictures in a video sequence.

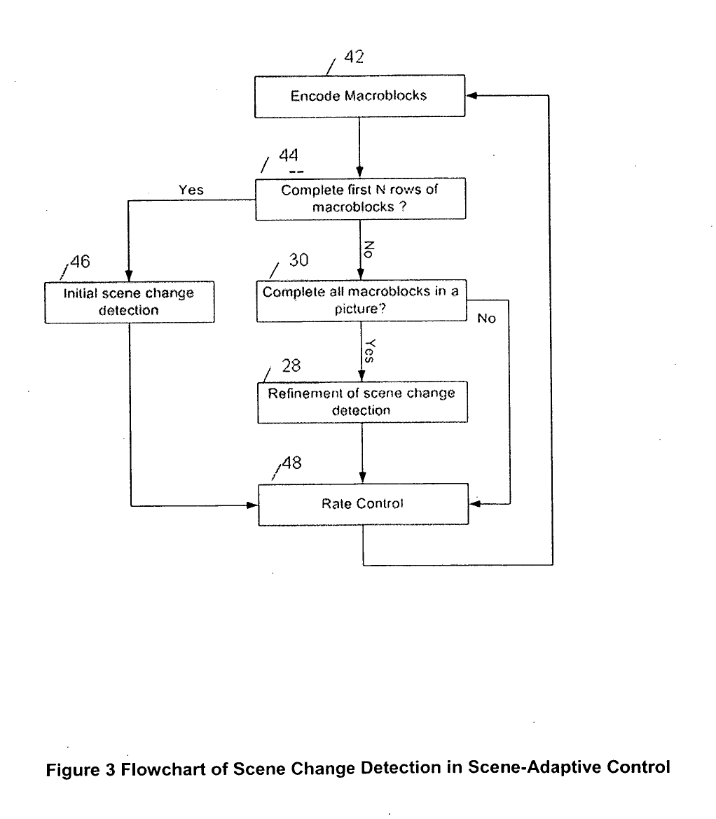

This detection may be implemented in scene adaptive rate control for real time video compression. This is the functionality implemented in the scene adaptive rate control unit 38 of FIG. 2 as described with reference to FIG. 3. Encoding of a macroblock initially takes place at 42. This comprises the compression of the video stream. H.264 is used as an example, and other encoders are similar.

At 44, a determination is made as to whether or not the first N rows of macroblocks under compression have been finished. If they have, then initial scene change detection estimation is made at 46. This feeds into the rate control adjustment unit 48, the output of which is an input to the encoding unit 42. During this initial scene change detection, when the first N rows of macroblocks have been compressed, different characteristics are assessed from intra coded frames and inter coded frames.

In an intra coded frame, the complexity of the frame content is used to determine whether or not a scene change has taken place. The complexity of Intra-coded frame content ComplexityOfNRow is defined as:

$$\begin{matrix}ComplexityOfNRow = f ( QP , UsedBitNumber ) \\ = QP\_Step ( QP ) * UsedBitNumber\end{matrix} \qquad ( 1 )$$

Where function f(a,b) is a monotonically increasing function of variables a and b. f(a,b)=a*b is selected. QP_Step( ) is used to map the average QP of the first N row of macroblocks to the QP_Step which is used to quantize the coefficients. For MPEG-4 and H.263, qp_step=QP_Step(qp)=2*qp, while for H.264, qp_step=QP_Step(qp)=2̂(qp−4)/6. UsedBitNumber is compressed bit number of the transform coefficients of the first N row of macroblocks.

Equation (1) can represent the video frame complexity more accurately than using the compressed data size UsedBitNumber alone as normally different intra-coded frames are encoded by using different OP values. Furthermore, different QP will result in different compressed data size. In H.264, each unit increase of QP lengthens the step size by 12% and reduces the bit rate by roughly 12%. If the QP value used to compress the frame is high and the generated bit number is also high, the scene is complex. Using Equation (1) to calculate the complexity is simple and robust for scene change detection.

For an intra-coded frame, a large change of video frame complexity is used as a characteristic for scene change detection. When a new scene appears, its complexity could subsequently change from high complexity to low complexity or from low complexity to high complexity. If the complexity change is larger than a threshold when compared with the average scene complexity, a scene change is detected, which can be represented as:

ComplexityOfNRow>TH1*AverComplexOfNRow

OR

ComplexityOfNRow<TH2*AverComplexOfNRow (2)

The parameters TH1 and TH2 are tuneable parameters. AverComplexOfNRow is the average complexity of N Rows in the past Intra coded frame, which is updated as:

AverComplexOfNRow=TH3*AverComplexOfNRow+TH4*ComplexityOfNRow (3)

Parameters TH3 and TH4 satisfy: TH3+TH4 equals to 1. Equation (3) is a recursive average of the complexity. This can reduce the required computation and memory as not much data from past frames has to be stored.

Based on the complexity of the first N rows of macroblocks and scene change detection result, a new rate control process is employed to change the QP values for subsequent macroblocks after the scene change is detected. For an inter coded frame, the scene change detection is performed after finishing compression of N rows of macroblocks at 44 based on the following different characteristics from those in an intra coded frame:
There is a large change of number of intra-coded macroblocks in relation to the average number of intra-coded macroblocks in an inter frame
There is a large change of temporal difference of inter-coded macroblocks to the average temporal difference per macroblock in an inter frame

A scene change happens when the correlation between two subsequent frames is small or the motion between them is larger than the search range of the motion estimation. If the scene has been changed, the motion estimation will fail. If the motion between two frames is too large then these two frames are considered to be in different scenes. Both situations will lead to large temporal differences. The Sum of Absolute temporal Difference (SAD), or other metrics such as mean absolute error (MAE) and mean square error (MSE), may be used to represent the temporal difference. However, using temporal difference alone may make a false detection of results when the video scene motion is very complex with a lot of detailed textures. In this case, the large change of number of intra-mode macroblocks to the average number of intra-coded macroblocks can remove most of the false detection results. If we only use the change of intra coded macroblock number for scene change detection, it can often fail in a scene with smooth texture accurately, as an exceptional number of intra-coded macroblocks could be generated. In this case, the temporal difference could be used together to increase the detection accuracy. Therefore, the combination of the above two characteristics improves the scene change detection accuracy.

Furthermore, these two characteristics can be obtained during motion estimation and mode selection process in real-time video compression systems. Therefore, no pre-analysis and/or two-pass processing are needed.

If the above two characteristics satisfy the following conditions, then a new scene is detected:

IntraMBOfNRow>TH5*NumMBOfNRow &&

IntraMBOfNRow>TH6*AverintraMBOfNRow &&

InterMBSADOfNRow>TH7*AverinterSADofNRow (4)

where, TH5, TH6 and TH7 are tuneable parameters; IntraMBOfNRow is the number of intra coded macroblocks in the first N rows of macroblocks; NumMBOfNRow is the total number of macroblocks in the first N rows, which is decided by the frame width. AverintraMBOfNRow is the average number of intra-coded macroblocks within the first N rows of MBs in the past compressed frames, which is updated as follows:

AverintraMBOfNRow=TH8*AverintraMBOfNRow+TH9*IntraMBOfNRow (5)

where TH8 and TH9 are tuneable parameters and TH8+TH9 equals to 1. Equation (5) is a recursive average of Intra-coded MB number. This can reduce the required computation and memory as not much data from past frames is stored.

InterMBSADOfNRow is the Inter SAD value per MB of the first N rows, which is output from motion estimation. AverinterSADofNRow is the average inter-SAD value per MB of the first N rows, which is updated as follows:

AverinterSADofNRow=TH10*AverinterSADofNRow+TH11*InterMBSADOfNRow (6)

where TH10 and TH11 are tuneable parameters and TH10+TH11 equals to 1. Equation (6) is a recursive average of Inter SAD value, in which the Average Inter SAD value of previous frame is used.

For most cases, scene change detection by using N row MB information can generate accurate detection results. However, if the upper part of a new scene is similar to the previous scene and the lower part is much more or less complex, the scene change detection by using only N rows of information could still generate some false results. Therefore, after completing the compression of an entire video frame, a refinement process of scene change detection is necessary to improve the detection accuracy further. However, based on the initial detection result, the rate control can adjust the quantisation parameters to avoid a large bit number for the first frame of new scene, which is necessary and important for the real-time compression system to achieve good performance under scene change.

Scene change detection is refined at the end of a frame at 28 if detection at 30 indicates completion of the frame. The process is the same as the process of initial scene change detection which is performed after the first N rows of macroblocks. This process can be summarized as:

ComplexityOflFrm=AverageQP_Step(QP)*UsedBitNumber

ComplexityOflFrm>TH12*AverComplexOflFrm OR

ComplexityOflFrm<TH13*AverComplexOflFrm (2)′

AverComplexOflFrm=TH14*AverComplexOflFrm+TH15*ComplexityOflFrm (3)′

IntraMBOfFrm>TH16*NumMBOfFrm &&

IntraMBOfFrm>TH17*AverintraMBOfFrm &&

InterMBSADOfFrm>TH18*AverInterSADOfFrm (4)′

AverintraMBOfFrm=TH19*AverintraMBOfFrm+TH20*IntraMBOfFrm (5)′

AverinterSADOfFrm=TH21*AverinterSADOfFrm+TH22*InterMBSADOfFrm (6)′

All parameters from TH12 to TH22 are tuneable; TH14+TH15 equals to 1; TH19+TH20 equals to 1; TH21+TH22 equals to 1;

If a new scene is detected, the statistical characteristics of the old scene can not be used in the future scene change detection. Therefore, the parameters AverComplexOflFrm, AverintraMBOfFrm, AverinterSADOfFrm, AverComplexOfNRow, AverIntraMBOfNRow, and AverInterSADofNRow are reset for next scene change detection.

The above scene detection processes has been implemented together with rate control process in a real-time video compression encoder.

The invention is advantageous since all the characteristics can be obtained during a real-time video compression process without pre-analysis and/or two-pass analysis required. In addition, the complexity data for both intra-coded and inter-coded pictures is dependent on two parameters, which results in more accurate and improved performance scene change detection. Also, the complexity definition for an intra-coded frame is more robust and accurate to characterise when detecting a scene change in intra-coded frames, than the use of generated bit numbers which can be problematic when there is a large change.

1. A method for scene change detection in intra-coded pictures for use with bit-rate control of a video compression system, the method comprising the steps of:
compressing each intra-coded picture in a video signal in turn;
determining complexity data from the compressed signal for each intra-coded picture after partial compression of the picture;
determining from the complexity data whether a scene change may have taken place; and
adjusting the compression step and allocated compressed bit number for intra-coded pictures after a scene change detection in dependence on the result of the determination, wherein, for an intra-coded picture, the complexity data is a monotonically increasing function of a quantisation parameter and a compressed bit number used in the compression step for the partial compression from which the complexity data is determined.

2. A method according to claim 1, in which the step of determining whether a scene change may have taken place comprises determining whether there has been a large change in complexity data.

3. A method according to claim 2 in which a scene change is determined to have taken place if the change in complexity data exceeds a threshold.

4. A method according to claim 3 in which the threshold is determined in relation to an average scene complexity in a previous intra-coded picture.

5. A method according to claim 1 comprising the step of determining the correlation between two subsequent intra-coded pictures and determining therefrom whether a scene change may have taken place.

6. A method according to claim 1 in which the step of determining whether or not a scene change may have taken place comprises determining change between two subsequent intra-coded frames and determining from the amount of change whether a scene may have changed.

7. A method according to claim 5 in which the determination between subsequent intra-coded pictures is performed after compression of a complete picture.

8. A method according to claim 1 comprising the additional step of determining complexity data after compression of a complete picture, determining from the complexity data whether a scene change may have taken place, and adjusting a quantization parameter and an allocated compressed bit number for subsequent pictures in dependence on the results of the determination.

9. A method according to claim 5 in which the step of determining whether a scene change may have taken place comprises determining the number of intra-coded macroblocks in a picture in relation to an average number of intra-coded macroblocks, and determining a temporal difference in intra-coded macroblocks in relation to an average temporal difference per macroblock.

10. A method for scene change detection in inter-coded pictures for use with bit-rate control of a video compression system, the method comprising the steps of:
compressing each inter-coded picture in a video signal in turn;
determining complexity data from the compressed signal for each inter-coded picture after partial compression of the picture;
determining from the complexity data whether a scene change may have taken place; and
adjusting the compression step and allocated compressed bit number for inter-coded pictures after a scene change detection in dependence on the result of the determination, wherein, for an inter-coded picture, the complexity data is determined from a combination of a) the change of temporal prediction difference in relation to the average prediction difference of previous inter-coded pictures, b) the intra-coded macroblock number in the current inter-coded picture in relation to the average intra-coded macroblock number in previous inter-coded pictures, and c) the intra-coded macroblock number in the current inter-coded picture in relation to the total encoded macroblock number in the current inter-coded picture.

11. A method according to claim 10, in which the step of determining whether a scene change may have taken place comprises determining whether there has been a large change in complexity data.

12. A method according to claim 11 in which a scene change is determined to have taken place if features a), b) and c) of the complexity data exceed a threshold.

13. A method according to claim 10 comprising the step of determining the correlation between two subsequent pictures and determining therefrom whether a scene change may have taken place.

14. A method according to claim 10 in which the step of determining whether or not a scene change may have taken place comprises determining change between two subsequent frames and determining from the amount of change whether a scene may have changed.

15. A method according to claim 13 in which the determination between subsequent pictures is performed after compression of a complete picture.

16. A method according to claim 10 comprising the additional step of determining complexity data after compression of a complete picture, determining from the complexity data whether a scene change may have taken place, and adjusting a quantization parameter and an allocated compressed bit number for subsequent pictures in dependence on the results of the determination.

17. A method according to claim 13 in which the step of determining whether a scene change may have taken place comprises determining the number of intra-coded macroblocks in a picture in relation to an average number of intra-coded macroblocks, and determining a temporal difference in intra-coded macroblocks in relation to an average temporal difference per macroblock.

18. An apparatus for scene change detection in intra-coded pictures with bit-rate control of a video compression system, the apparatus comprising:
means for compressing each intra-coded picture in a video signal in turn;
means for determining complexity data from the compressed signal for each intra-coded picture after partial compression of the picture;
means for determining from the complexity data whether a scene change may have taken place; and
means for adjusting the compression step and allocated compressed bit-number for intra-coded pictures after scene change detection in dependence on the result of the determination,
wherein, for an intra-coded picture, the complexity data is a monotonically increasing function of a quantisation parameter and a compressed bit number used in the compression step for the partial compression from which the complexity data is determined.

19. An apparatus according to claim 18 in which the means for determining whether a scene change may have taken place comprises means for determining whether there has been a large change in complexity data.

20. An apparatus according to claim 19 in which the means for determining whether a scene change has taken place is operable to indicate that a scene change has taken place if a change in complexity data exceeds a threshold.

21. An apparatus according to claim 20 in which the threshold is determined in relation to an average scene complexity in a previous intra-coded picture.

22. An apparatus according to claim 18 comprising means for determining the correlation between two subsequent intra-coded pictures and determining therefrom whether a scene change may have taken place.

23. An apparatus according to claim 18 in which the means for determining whether or not a scene change may have taken place comprises means for determining change between two subsequent intra-coded frames and means for determining from the amount of change whether a scene change may have changed.

24. An apparatus according to claim 22 in which the means for determining whether a scene change may have taken place operates after compression of a complete picture.

25. An apparatus according to claim 18 comprising means for determining complexity data after compression of a complete picture, and means for determining from the complexity data whether a scene change may have taken place, and means for adjusting a quantization parameter and an allocated compressed bit-number for subsequent pictures, in dependence on the results of this determination.

26. An apparatus for scene change detection in inter-coded pictures for use with bit-rate control of a video compression system, the apparatus comprising:
means for compressing each inter-coded picture in a video signal in turn;
means for determining complexity data from the compressed signal for each inter-coded picture after partial compression of the picture;
means for determining from the complexity data whether a scene change may have taken place; and
means for adjusting the compression step and allocated compressed bit-number for inter-coded pictures after scene change detection in dependence on the result of the determination,
wherein, for an inter-coded picture, the complexity data is determined from a combination of a) the change of temporal prediction difference in relation to the average prediction difference of previous inter-coded pictures, b) the intra-coded macroblock number in the current inter-coded picture in relation to the average intra-coded macroblock number in previous inter-coded pictures, and c) the intra-coded macroblock number in the current inter-coded picture in relation to the total encoded macroblock number in the current inter-coded picture.

27. An apparatus according to claim 26 in which the means for determining whether a scene change may have taken place comprises means for determining whether there has been a large change in complexity data.

28. An apparatus according to claim 27 in which the means for determining whether a scene change has taken place is operable to indicate that a scene change has taken place if features a), b) and c) of the complexity data exceed a threshold.

29. An apparatus according to claim 26 comprising means for determining the correlation between two subsequent pictures and determining therefrom whether a scene change may have taken place.

30. An apparatus according to claim 26 in which the means for determining whether or not a scene change may have taken place comprises means for determining change between two subsequent frames and means for determining from the amount of change whether a scene may have changed.

31. An apparatus according to claim 29 in which the means for determining whether a scene change may have taken place operates after compression of the complete picture.

32. An apparatus according to claim 26 comprising means for determining complexity data after compression of a complete picture, and means for determining from the complexity data whether a scene change may have taken place, and means for adjusting a quantization parameter and an allocated compressed bit-number for subsequent pictures in dependence on the results of this determination.
